(19) United States
(12) Patent Application Publication
(10) Pub. No.: US 2026/0169680 A1
(43) Pub. Date: Jun. 18, 2026

(54) SPATIAL AUDIO WITH AN IMAGE

(71) Applicant: GOOGLE LLC, Mountain View, CA (US)

(72) Inventors: Kathleen Alexandra Bryan, Mountain View, CA (US); Shiblee Hasan, Santa Clara, CA (US)

(21) Appl. No.: 19/425,270

(22) Filed: Dec. 18, 2025

Related U.S. Application Data
(60) Provisional application No. 63/735,744, filed on Dec. 18, 2024.

(51) Int. Cl. G06F 3/16; G06T 17/00; H04S 7/00

(52) U.S. Cl. CPC G06F 3/165; G06T 17/00; H04S 7/30

(57) ABSTRACT

According to at least one implementation, a method includes generating a three-dimensional scene from at least one two-dimensional image and generating an image of the three-dimensional scene. The method further includes identifying audio content associated with the three-dimensional scene based on the at least one two-dimensional image, and determining audio associated with the image based on a spatialization of the audio content from a perspective associated with the image of the three-dimensional scene.

### CROSS-REFERENCE TO RELATED APPLICATION

This application claims priority to U.S. Provisional Patent Application No. 63/735,744, filed on Dec. 18, 2024, the disclosure of which is incorporated herein by reference in its entirety.

### BACKGROUND

Wearable computing devices, such as head-mounted displays (HMDs), smart glasses, or other extended reality (XR) systems, are designed to be worn by a user to provide an immersive digital experience. These devices can generate augmented reality (AR), virtual reality (VR), or mixed reality (MR) environments by presenting computer-generated information that either overlays the user's view of the physical world or creates an entirely virtual setting. Such devices typically include processors, memory, sensors, and various output components to facilitate user interaction with the generated content.

To create an immersive experience, content is presented to the user through a combination of visual and auditory outputs. Visual information is often rendered on small displays positioned in front of the user's eyes. These displays may provide stereoscopic images, with a separate view for each eye, to create a sense of three-dimensional (3D) depth. Concurrently, audio content can be delivered through integrated speakers or headphones. This audio may be spatialized to make sounds appear to originate from specific locations within the virtual or augmented environment, further enhancing the user's sense of presence.

### SUMMARY

This disclosure describes systems and methods for creating three-dimensional (3D) experiences from two-dimensional (2D) images. In other words, this disclosure describes a technology that transforms ordinary photos into immersive 3D experiences with sound. The system can intelligently reconstruct a two-dimensional 2D photo into a 3D scene, and then add a realistic, spatialized soundscape. For example, if the photo is of a waterfall, the system creates a 3D version of the scene and adds the sound of rushing water that seems to come directly from the waterfall. The process begins by generating a 3D scene from a source image, such as a photograph. The system then analyzes the visual content of the image to identify key objects, activities, or environmental features. Based on this analysis, the system identifies or generates appropriate audio content to accompany the visual scene.

The identified audio content is then spatialized within the 3D scene to create a realistic soundscape. This means sounds are positioned so they appear to originate from their respective sources in the 3D environment, from the perspective of a viewer. For example, sounds can be selected from a database based on recognized objects or dynamically created using generative artificial intelligence. This process, which can simulate audio propagation, provides a cohesive and engaging audiovisual experience for presentation on stereoscopic displays or other wearable devices.

In some aspects, the techniques described herein relate to a method including: generating a three-dimensional scene from at least one two-dimensional image; generating an image of the three-dimensional scene; identifying audio content associated with the three-dimensional scene based on the at least one two-dimensional image; and determining audio associated with the image based on a perspective for the image in the three-dimensional scene and the audio content.

In some aspects, the techniques described herein relate to a computer-readable storage medium having program instructions stored thereon that, when executed by at least one processor, direct the at least one processor to perform a method, the method including: generating a three-dimensional scene from at least one two-dimensional image; generating an image of the three-dimensional scene; identifying audio content associated with the three-dimensional scene based on the at least one two-dimensional image; and determining audio associated with the image based on a perspective for the image in the three-dimensional scene and the audio content.

In some aspects, the techniques described herein relate to a computing system including: at least one processor; a computer-readable storage medium operatively coupled to the at least one processor; and program instructions stored on the computer-readable storage medium that, when executed by the at least one processor, direct the computing system to perform a method, the method including: generating a three-dimensional scene from at least one two-dimensional image; generating an image of the three-dimensional scene; identifying audio content associated with the three-dimensional scene based on the at least one two-dimensional image; and determining audio associated with the image based on a perspective for the image in the three-dimensional scene and the audio content.

The accompanying drawings and the description below outline the details of one or more implementations. Other features will be apparent from the description, drawings, and claims.

### BRIEF DESCRIPTION OF THE DRAWINGS

FIG. 1 illustrates an operational scenario of providing spatial audio with an image according to an implementation.

FIG. 2 illustrates a method of providing spatial audio with an image according to an implementation.

FIG. 3 illustrates an operational scenario of using a generative model to generate audio associated with a 3D scene according to an implementation.

FIG. 4 illustrates an operational scenario of using object identification to determine audio associated with a 3D scene according to an implementation.

FIG. 5 illustrates an operational scenario of generating different audio for different scene perspectives according to an implementation.

FIG. 6 illustrates a computing system for generating audio in association with a 3D scene according to an implementation.

### DETAILED DESCRIPTION

The systems and techniques described herein solve the technical problem of making three-dimensional (3D) scenes reconstructed from two-dimensional (2D) images feel more realistic and immersive. The solution involves generating a believable and spatially accurate soundscape to accompany the visual content. The process begins by generating a 3D scene from a source 2D image, such as a photograph. The system then analyzes the visual content of the image to identify key objects and environmental features. Based on what is identified, the system selects appropriate audio from a database or dynamically creates new audio using generative artificial intelligence. For example, if the source image is a photo of a waterfall, the system can be configured to identify the waterfall, trees, birds, and the like, and then generate sounds of rushing water, rustling leaves, and chirping birds. Crucially, this audio content is then spatialized from the perspective of a viewer within the 3D scene, so the sounds appear to originate from their respective sources. This spatialization can simulate audio propagation, making sounds farther away seem quieter. The final output is a cohesive audiovisual experience, such as a stereoscopic image with corresponding spatial audio, that can be presented on a wearable device to create a deeply engaging and lifelike virtual or augmented reality environment.

Wearable devices, such as head-mounted displays or smart glasses, present this combined audiovisual content to the user through specialized output components. Visual information, such as stereoscopic images, is typically rendered on high-resolution microdisplays and projected into the user's field of view, often using optical systems such as waveguides. By presenting a distinct image to each eye, these devices create a convincing perception of 3D depth, allowing the user to experience the generated immersive scene. Concurrently, the spatialized audio is delivered through integrated speakers or headphones, employing techniques like binaural rendering to make sounds appear to originate from their specific locations within the virtual environment. The precise synchronization of these visual and auditory outputs is crucial to creating a cohesive, believable experience that grounds the user in the generated 3D scene. As used herein, a “wearable device” refers to an electronic apparatus designed for user wear that provides an immersive digital experience by generating and presenting synchronized visual and auditory outputs, including presenting stereoscopic images to create a perception of depth and providing spatialized audio corresponding to a virtual scene.

In some implementations, to generate the immersive content with spatialized audio, a system, such as the wearable device itself and/or another computing system, is provided with one or more 2D images. As used herein, a 2D image refers to a digital representation of visual information, such as a photograph, that captures a scene from a particular viewpoint. This image can be structured as a 2D grid of pixels, where each pixel contains color and intensity values. In some instances, the 2D image can be part of a multimedia image file. As used herein, a “multimedia image file” refers to a data container encapsulating multiple media types associated with a single capture event, including a primary still image, a video sequence, and an audio sample recorded during the capture of the video sequence. Such a file may therefore include associated metadata, such as the brief audio sample that constitutes additional audio content. This computing system may be realized in various forms, such as a server, a personal computer, or a mobile device. In other implementations, the system may comprise a distributed architecture in which processing is shared between a client device (e.g., the wearable device) and a remote server or a companion device communicatively coupled to the wearable device. Regardless of the specific form, the system includes one or more processors and memory storing instructions that, when executed by the processors, cause the system to perform the techniques described.

The system can be configured to process these images to perform a 2D-to-3D reconstruction, generating a volumetric representation of the scene (i.e., 3D scene). As used herein, a 3D scene refers to a computer-generated model that represents an environment in three dimensions, capturing not only the visual appearance of objects but also their spatial relationships and geometric properties (e.g., depth, shape, and volume). This model can be composed of a collection of geometric primitives, such as polygons or point clouds, along with associated texture, lighting, and material information. Unlike a 2D image, which provides a flat projection of a scene from a single viewpoint, a 3D scene constitutes a comprehensive spatial representation that can be navigated and viewed from multiple perspectives. This can be achieved using a deep learning model, such as a convolutional neural network (CNN), trained to infer spatial information from a single image or a set of images. In some implementations, the model first generates a depth map, which estimates the distance of each point in the scene from the perspective of the original camera. This depth information is then used to construct a 3D mesh or point cloud, effectively creating the geometric structure of the environment depicted in the photograph. In some examples, techniques like semantic segmentation may also be employed to identify and classify different regions and objects within the image, such as the sky, ground, buildings, or foliage, which aids in creating a more accurate and structured 3D model.

Once the foundational geometry of the 3D scene is established, the system can further refine the model. The original 2D image provides the texture information that is mapped onto the corresponding surfaces of the 3D mesh, giving the scene its realistic appearance. The objects identified during segmentation can be treated as distinct entities within this 3D space, positioned according to the depth map. For example, a tree identified in the foreground of the photo will be represented as a 3D object closer to the virtual viewpoint than a mountain range in the background. More advanced implementations may utilize technologies such as Neural Radiance Fields (NeRFs), which use neural networks to synthesize novel views of a complex scene from a partial set of input images, resulting in a highly detailed and photorealistic 3D representation.

After a scene is generated, the system can generate or capture an image of the 3D scene. To accomplish this, a virtual camera can be positioned within the reconstructed 3D environment, establishing a specific viewpoint from which to render the scene. This viewpoint might correspond to the original perspective of the source photograph or be a novel position that allows for new views of the environment. For creating an immersive, 3D experience, the system can be configured to generate a stereoscopic image. This involves rendering two separate images of the scene from slightly offset virtual camera positions, simulating the interpupillary distance between a user's eyes. The resulting left-eye and right-eye images form a stereoscopic pair that, when viewed on a compatible display such as a head-mounted device, produces a convincing perception of depth and volume.

As used herein, a “perspective” refers to a defined viewpoint within the 3D scene, characterized by at least a set of 3D coordinates and an orientation, from which the scene is rendered to generate an image and spatialize audio content. Perspective can refer to the virtual vantage point from which a user experiences the 3D scene, established by a virtual camera and serving as the reference for rendering both the visual image and the corresponding spatialized audio.

As described herein, an image of a 3D or 3D scene refers to a 2D rendering generated by projecting the geometric and texture data of a computer-generated 3D scene onto a virtual image plane from a specific viewpoint, wherein the viewpoint is defined by the position and orientation of a virtual camera within the scene.

As described herein, a “stereoscopic image” refers to a set of at least two 2D images, comprising a left-eye image and a right-eye image, rendered from slightly offset viewpoints within a 3D scene to simulate human interpupillary distance, wherein the set of images, when presented to a user's respective eyes, creates a perceptual illusion of 3D depth.

In addition to generating the image, the system can further be configured to identify audio content associated with the 3D scene. As used herein, audio content refers to any digital representation of sound intended to be paired with the visual information of the 3D scene. This can encompass a wide range of auditory data, from discrete sound effects, such as a bird's chirp or a car horn, to continuous ambient soundscapes, like the murmur of a crowd or the rush of a waterfall. The content may be pre-recorded and stored in various digital formats (e.g., WAV, MP3) or dynamically synthesized by a generative model. The fundamental purpose of the audio content is to provide an auditory dimension that corresponds contextually to the visual elements depicted in the scene, enhancing realism and immersion. In some implementations, audio content may also refer to a digital data structure that encodes sound, which is selected or generated by a system to correspond to the visual elements of a three-dimensional scene. In some implementations, audio content may be any sound data, whether retrieved from a database or synthesized by a model, that is used by a system to create a soundscape for a virtual environment, wherein the selection or synthesis is based on an analysis of the visual components of that environment. In some implementations, audio content can be the auditory component of an audiovisual experience, which is identified or created by a system to contextually match a 3D scene that has been generated from a 2D image.

This identification process can be performed by analyzing the visual content of either the original 2D image or the reconstructed 3D scene. In one implementation, the system utilizes an object recognition model, such as a convolutional neural network (CNN), to identify and classify discrete objects and environmental features. For example, if the source image is a photograph of a bustling city street, the model might identify objects like a bus, car, and pedestrians. The system can then be configured to query a pre-populated audio database. As used herein, a “database” refers to a structured collection of digital audio files stored in a non-transitory computer-readable medium, wherein the collection is organized to associate each audio file with at least one object class, thereby enabling the retrieval of an audio file based on an identified object. This database maps these object classes to corresponding sound files, and based on the identified objects, the system would select audio clips such as the rumble of a bus engine, the hum of a car, and the indistinct chatter of a crowd.

As used herein, an “object” refers to a distinct and classifiable entity within a 2D image or 3D scene, identified through computational analysis of visual features such as shape, texture, and color. An object corresponds to a semantically meaningful element of the scene (e.g., a vehicle, a person, a natural feature like a waterfall) and serves as the basis for selecting or generating contextually appropriate audio content, which is then anchored to the object's location within the 3D scene.

In other implementations, the system leverages generative artificial intelligence to dynamically synthesize audio content. This approach allows for the creation of unique and context-aware soundscapes that are not limited to a predefined library of sounds. For instance, after identifying a river in an image, instead of selecting a generic river sound, a generative model could synthesize the audio based on visual cues. The model might analyze inferred properties such as the river's width, the turbulence of the water visible in the image, and its distance from the virtual camera (as determined by the depth map) to generate a sound that accurately reflects a gentle stream or a powerful current.

As used herein, generative artificial intelligence (generative AI) refers to a class of machine learning models designed to determine the underlying patterns, structures, and distributions from a training dataset and subsequently generate new, synthetic data that exhibits similar characteristics. Unlike discriminative models, which are trained to classify or predict outcomes from input data, generative models can produce novel content, such as images, text, or, in this context, audio. These models can be conditioned on specific inputs, such as the visual features of an image or the geometric properties of a 3D scene, to guide the synthesis process, enabling the creation of unique and contextually appropriate audio that is not merely a reproduction of pre-existing sound files.

In some implementations, dynamically may describe a process or action that occurs in real-time or on-the-fly, in response to changing inputs or conditions, rather than being predetermined or static. In some implementations, dynamically generate content may refer to the synthesis of new data, such as an audio file, at the time of need based on the current context, as opposed to retrieving pre-existing data from a storage medium. In some implementations, an action performed dynamically can be one that is continuously adjusted or recalculated in response to a stream of input data, such as a user's changing perspective, to maintain a desired state or relationship, such as the synchronization between audio and video.

To enable this generative capability, the model can be configured (i.e., trained) on a large and diverse dataset that pairs visual information with corresponding audio data. This training process involves exposing the model to a vast number of examples, where each example consists of an input, such as an image or its derived 3D scene representation, and a target output, which is the contextually appropriate audio for that scene. The model, which can include a deep neural network in some examples, can be configured to identify complex patterns and correlations between the visual features, such as objects, textures, and spatial arrangements, and the acoustic properties of the associated sounds, including frequency, timbre, and temporal dynamics.

For example, a training data point might include a photograph of a busy city intersection paired with a multi-layered audio recording of that environment, including the sounds of car engines, horns, distant sirens, and the general murmur of pedestrian traffic. Another example could be an image of a tranquil beach at sunset, matched with an audio file containing the gentle lapping of waves, the distant cry of a seagull, and a soft breeze. By processing pairs, the model can be configured to associate specific visual cues (e.g., the presence of a car, the texture of water, the density of a crowd) with their characteristic sounds, enabling the model to generate a believable and contextually accurate soundscape for a new, previously unseen image.

For instance, when presented with a new photograph of a public park, the trained model can analyze the image to identify key elements such as a water fountain, several trees, and people scattered across a lawn. Based on the defined associations, the model would then synthesize a cohesive soundscape. It might generate the sound of splashing water, positioning it in the 3D scene according to the fountain's location. Concurrently, it could produce the ambient sound of rustling leaves and the indistinct chatter of people, with the volume and characteristics of these sounds modulated by the visual cues, such as the density of the foliage or the number of people visible.

Furthermore, generative AI can be used to augment existing audio or create more complex ambient environments. If the source 2D image is a “live photo” that includes a brief audio sample, a generative model can analyze the acoustic properties of that sample and seamlessly extend it into a longer, continuous ambient track, preserving the authentic sound of the original moment. In another example, a hybrid approach may be used where the system selects a base sound from a database (e.g., a bird's song) and then uses a generative model to apply environmental effects based on the 3D scene, such as adding reverberation consistent with a dense forest or attenuation to simulate distance. This combination of object recognition, database retrieval, and generative synthesis provides the technical effect of a flexible and powerful framework for creating a rich and believable auditory experience.

To enable this generative capability, the model can be configured (i.e., trained) on a dataset that pairs visual information with corresponding audio data. This dataset can be curated by collecting a number of images and associating them with recorded or designed soundscapes. For instance, a training example might consist of an image of a serene forest paired with an audio recording of gentle wind rustling through leaves and the distinct call of a specific bird species identified in the image. Another example could feature a bustling cafe scene matched with a complex audio mix of clinking cups, low chatter, and the hum of an espresso machine. By processing this dataset, the model can be configured to map specific visual features and identified objects, such as the density of foliage, the type of bird, or the presence of kitchen equipment, to the acoustic properties that define an appropriate and realistic soundscape, allowing it to synthesize novel and contextually accurate audio for new scenes.

Once the audio content is identified, the system further determines audio associated with the generated image from the 3D scene using spatialization of the audio content from a perspective associated with the image of the scene. As used herein, spatialization refers to the process of rendering audio content to create the perceptual illusion that sounds are emanating from specific points within the 3D scene, relative to the listener's perspective. This involves manipulating audio signals to embed directional, distance, and environmental cues, thereby creating a cohesive and immersive soundscape that corresponds to the visual elements of the scene.

In some implementations, this spatialization is achieved by associating each identified audio clip with the 3D coordinates of its corresponding source object within the reconstructed scene. For instance, the sound of a bird chirping is linked to the 3D position of the bird model, and the sound of rushing water is anchored to the geometry of the waterfall. The system then calculates the position and orientation of these sound sources relative to the virtual camera's perspective, which represents the user's viewpoint. This relative positioning information—including distance, azimuth, and elevation—forms the basis for rendering the audio.

To create a convincing perception of auditory depth and directionality, the system can employ advanced rendering techniques such as binaural audio. This process utilizes a Head-Related Transfer Function (HRTF), which is a model that characterizes how sound waves are filtered by the listener's head, torso, and outer ears before reaching the eardrums. By applying an appropriate HRTF to a monophonic sound source, the system can generate two distinct audio signals, one for the left ear and one for the right. These signals contain the subtle time, level, and spectral differences that the human brain interprets as directional cues, making the sound appear to originate from a specific point in 3D space when delivered via headphones or specialized speakers.

Furthermore, the system can simulate realistic sound propagation to enhance immersion. This involves modeling environmental acoustic effects based on the geometry of the 3D scene. For example, distance attenuation is applied to make sounds from farther objects quieter than those from nearby objects. The system may also simulate reverberation by calculating how sound waves would reflect off surfaces within the scene, such as canyon walls or the interior of a building. Similarly, occlusion effects can be modeled, where a sound is muffled or partially blocked if there is an object between its source and the listener. By combining source positioning, binaural rendering, and environmental acoustic simulation, the system generates a cohesive and spatially accurate soundscape that is precisely synchronized with the visual perspective of the generated image.

As used herein, “a simulation of audio propagation” refers to the computational process of modeling how sound travels from a source to a listener's perspective within a virtual 3D environment, taking into account the geometry and material properties of that environment. This process accounts for the physical phenomena that affect sound waves, including distance attenuation, where sound intensity decreases over distance; reverberation, which results from sound waves reflecting off surfaces within the scene; and occlusion, where sound is muffled or blocked by objects positioned between the source and the listener. By calculating these environmental acoustic effects, the simulation generates an audio output that more accurately represents how sound would behave in a real-world equivalent of that space, thereby enhancing the realism and immersion of the experience.

The resulting stereoscopic image and the corresponding spatial audio are then provided to the user through a wearable device, such as a head-mounted display (HMD). The HMD's displays present the left-eye and right-eye images, creating the perception of a 3D scene, while its integrated audio system delivers the binaural audio tracks. For example, a user viewing the reconstructed scene of a waterfall would not only see the waterfall in 3D but would also perceive the sound of rushing water as originating from the waterfall's specific location in that space. If the user turns their head, the perceived origin of the sound shifts accordingly, maintaining a consistent spatial relationship between the visual and auditory elements. The technical effect of this synchronized audiovisual presentation is a significant enhancement in realism and immersion. By automatically generating and spatially anchoring a believable soundscape to a reconstructed 3D scene, the system transforms a static 2D image into a dynamic and engaging virtual experience that more accurately simulates the sensory richness of a real-world environment.

For example, a user wearing a pair of smart glasses can select a 2D photograph from their personal library, such as an image of a bustling city square captured during a family vacation. The system, either on the wearable device or a connected computing system, initiates the 2D-to-3D reconstruction process, generating a volumetric model of the square, including the surrounding buildings, a central fountain, and various pedestrians. Concurrently, an object recognition model analyzes the image and identifies key sound-producing elements: the fountain, a street musician playing a guitar, and the crowd itself. The system then selects or generates appropriate audio content for each element. When the user activates the experience, the static 2D image transforms into a stereoscopic 3D scene with a convincing perception of depth. The technical effect is immediately apparent as the spatialized soundscape is presented. The user does not hear a generic city soundscape; instead, using binaural rendering, the sound of splashing water is perceived as originating directly from the 3D model of the fountain in the center of their view, while the distinct melody of a guitar is perceived as coming from the musician's specific location off to the right, creating an immediate and powerful sense of presence within the captured moment.

As the user continues to interact with this reconstructed memory, the system demonstrates its ability to create a dynamic and responsive environment. If the user turns their head to the left, away from the musician and towards a different part of the square, the system tracks this change in perspective. In real-time, the spatialization engine recalculates the audio rendering based on the new viewpoint. The guitar music, now originating from behind the user's right shoulder, becomes quieter and its acoustic properties are altered by the HRTF to reflect the new direction, while the ambient sounds of the crowd on the left become more prominent. If the user then virtually moves closer to the fountain, the system simulates audio propagation; the sound of the water grows louder and more detailed, while the more distant sounds of the musician and chatter are attenuated. This continuous, real-time adjustment of the spatialized audio based on the user's perspective ensures that the auditory and visual components remain perfectly synchronized. The technical effect is the transformation of a static photograph into a navigable, multi-sensory virtual space, solving the problem of silent, lifeless 3D reconstructions by providing a deeply immersive and emotionally resonant experience.

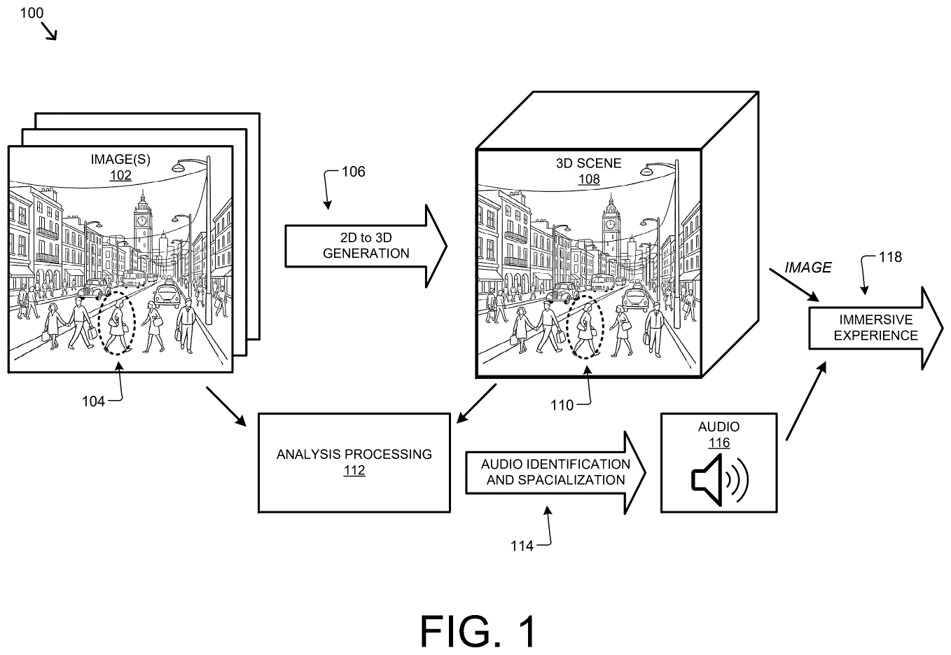

FIG. 1 illustrates an operational scenario 100 of providing spatial audio with an image according to an implementation. Operational scenario 100 includes image(s) 102 with object(s) 104, 2D-to-3D generation 106, 3D scene 108 with object(s) 110, analysis processing 112 that provides audio identification and spatialization 114 and audio 116, and immersive experience 118. Operational scenario 100 can be performed by one or more computing systems, such as a wearable device (e.g., a head-mounted display, smart glasses) and/or a network-based system, to provide a 3D scene with immersive audio.

In operational scenario 100, the process begins with the system obtaining one or more 2D images 102 that depict one or more objects 104. The system performs a 2D-to-3D generation 106 on the image(s) 102 to create a volumetric 3D scene 108, which includes 3D object(s) 110 corresponding to the object(s) 104. An analysis processing 112 then performs audio identification and spatialization 114 to determine appropriate sounds for the scene. To do this, the analysis processing 112 can analyze the visual content of the original one or more images 102 and/or the reconstructed 3D scene 108 to identify objects and environmental features. Based on this analysis, corresponding audio 116 is identified or generated and then spatialized within the 3D scene 108 based on a virtual camera perspective in the 3D scene. The combination of the 3D scene 108 and the correctly positioned audio 116 results in a cohesive and immersive experience 118 for a user.

As a further description of operational scenario 100, 2D image(s) 102 represent a digital representation of visual information, such as a photograph, that captures a scene from a particular viewpoint. In some examples, each image is structured as a 2D grid of pixels, where each pixel contains color and intensity values. The 2D image(s) 102 can be a single static picture or a short sequence of frames, as in a “live photo,” and may include associated metadata or audio content that was captured simultaneously with the image exposure. These images can be obtained by the system in various ways, such as being captured using an image sensor on a device like a smartphone or being retrieved from a digital storage medium where they are stored in a standard image file format.

After the images are received, the system can perform a 2D-to-3D generation 106 to generate a volumetric representation of the scene, as the 3D scene 108. As used herein, a 3D scene 108 refers to a computer-generated model that represents an environment in three dimensions, capturing not only the visual appearance of objects but also their spatial relationships and geometric properties (e.g., depth, shape, and volume). 3D scene 108 can be composed of a collection of geometric primitives, such as polygons or point clouds, along with associated texture, lighting, and material information. The generation process can be achieved using a deep learning model, such as a CNN, configured to infer spatial information from the image(s) 102. For example, the model may first generate a depth map, which estimates the distance of each point in the scene from the perspective of the original camera. This depth information is then used to construct a 3D mesh or point cloud, creating the geometric structure of the 3D scene 108. The original image(s) 102 can then provide the texture information that is mapped onto the corresponding surfaces of the 3D mesh, giving the scene its realistic appearance. More advanced implementations may utilize technologies like NeRFs to synthesize novel views of a complex scene from a partial set of input images. For example, if the one or more images 102 is a photograph of a waterfall, the 2D-to-3D generation 106 would create a 3D scene 108 that includes a 3D mesh representing the waterfall, surrounding rocks, and foliage as 3D objects 110.

In addition to generating the 3D scene 108, operational scenario 100 further performs analysis processing 112 to identify audio content and spatialize the audio content for a perspective associated with the 3D scene. In some implementations, the analysis processing 112 utilizes an object recognition model to identify and classify discrete objects and environmental features within the image(s) 102. For example, if image(s) 102 depicts a park scene, the model might identify objects such as a fountain, birds, and trees. This identification process is used to select appropriate audio content. As used herein, audio content refers to a digital representation of sound intended to be paired with the visual information of the 3D scene. This content, which can include discrete sound effects (e.g., a bird's chirp) or continuous ambient soundscapes (e.g., the rush of a waterfall), is typically pre-recorded and stored in a database in various digital formats, such as WAV or MP3. The system queries this database by mapping the identified object classes to their corresponding sound files, thereby selecting the appropriate audio 116 for the scene.

In some implementations, in addition to or in place of using object recognition, the system can generate audio for the scene based on image characteristics. In this approach, a generative AI model, such as a neural network, is utilized to dynamically synthesize audio content. This model can be trained on a dataset that pairs visual information with corresponding audio data, enabling it to identify the complex relationships between visual features and their acoustic signatures. For instance, instead of merely selecting a generic waterfall sound, the model can analyze visual cues within the image, such as the perceived volume of water, the turbulence of the rapids, and the surrounding environment, to generate a sound that is uniquely tailored to the specific scene.

This generative capability also allows for the creation of unique and context-aware soundscapes that are not limited to a predefined library of sounds. Furthermore, generative AI can be used to augment or extend existing audio. If the source image(s) 102 include a brief audio sample, as in a “live photo,” the generative model can analyze the acoustic properties of this sample and seamlessly extend it into a longer, continuous ambient track. A hybrid approach is also possible, where the system selects a base sound from a database and then uses a generative model to apply environmental effects based on the 3D scene 108, such as adding reverberation consistent with the identified geometry.

Once the audio content is generated, analysis processing 112 can perform spatialization to determine audio 116, wherein audio 116 reflects the spatialized sound associated with a perspective of scene 108. This spatialization process involves associating each identified sound with the 3D coordinates of its corresponding source object (from object(s) 110) within the 3D scene 108. For a given perspective, established by a virtual camera, the system renders these sounds using techniques such as binaural audio, which employs a Head-Related Transfer Function (HRTF) to generate distinct left and right ear signals. This creates the perception that a sound is originating from a specific direction and location in 3D space. The system can also simulate environmental acoustics to enhance realism. For example, it can apply distance attenuation, making sounds from objects farther away in the scene seem quieter, and model reverberation based on the geometry of the 3D scene 108. The resulting audio 116 is a fully spatialized soundscape, precisely synchronized with the visual content, which is then presented to the user to create the immersive experience 118.

For example, in the case where 3D scene 108 depicts a waterfall, the system identifies a perspective from which the 3D scene 108 is to be viewed (e.g., a virtual camera position). The audio 116 is then determined based on the spatialization of the waterfall sound from this perspective. The sound of the rushing water is anchored to the 3D coordinates of the waterfall object 110. From the identified perspective, the analysis processing 112 can apply distance attenuation, making the waterfall sound quieter if the viewpoint is far away, and can use binaural rendering to make the sound appear to originate from the specific direction of the waterfall relative to the viewer.

The technical problem solved by operational scenario 100 is the lack of realism and immersion in 3D scenes that are reconstructed from 2D images, as these scenes are typically silent and lack the auditory cues of a real-world environment. The technical effect of the described process is the automated creation of a cohesive, immersive audiovisual experience. By analyzing the visual content to identify or create a contextually appropriate soundscape and then spatializing that audio to match the 3D geometry and a specific viewpoint, the system transforms a static photograph into a dynamic, multi-sensory virtual environment. This significantly enhances the user's sense of presence, making the reconstructed scene feel more believable and engaging.

In some implementations, in addition to providing spatialized audio, the system can further be configured to generate stereoscopic images for the user when viewing the scene. To generate a stereoscopic image, the system leverages the volumetric data of the 3D scene 108. It positions two virtual cameras within this reconstructed environment, separated by a small horizontal distance that simulates the average interpupillary distance (IPD) between a person's eyes. The system then renders two distinct images of the scene: one from the perspective of the left virtual camera and another from the perspective of the right virtual camera. This pair of images, representing the left-eye and right-eye views, constitutes the stereoscopic image. When these images are presented to the user on a compatible display, such as the separate displays for each eye in a head-mounted device, the user's brain fuses them into a single, unified perception with a strong sense of 3D depth and volume.

The technical effect of combining these stereoscopic images with the spatialized audio 116 is a significant enhancement of realism and immersion. The stereoscopic view creates a convincing visual representation of 3D space, and the spatialized audio anchors the generated sounds within that space. For example, suppose a bird is identified on a tree branch to the user's left. In that case, the stereoscopic image will render the tree with perceptible depth, making it appear physically located to the left. Concurrently, the binaural rendering of the bird's chirp will make the sound seem to originate from that same precise location. This perfect alignment of visual and auditory spatial cues creates a cohesive multi-sensory experience, solving the problem of flat, lifeless 3D reconstructions and giving the user a powerful sense of presence within the virtual environment.

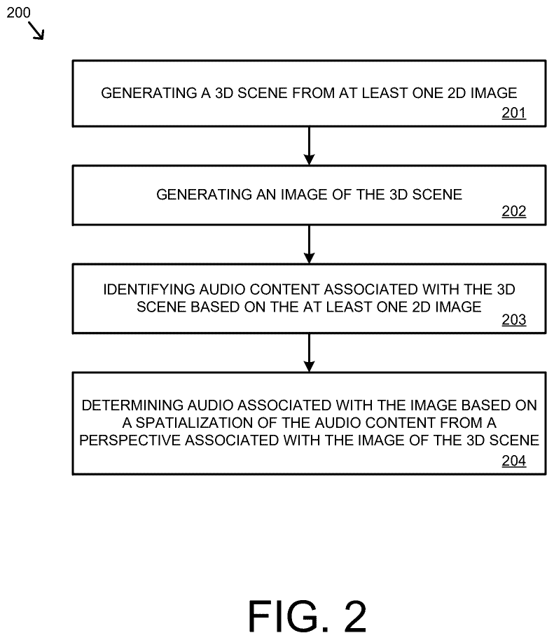

FIG. 2 illustrates method 200 of providing spatial audio with an image according to an implementation. The steps of method 200 can be performed by a computing system, such as a wearable device (e.g., a head-mounted display, smart glasses) and/or a network-based system, that has one or more hardware processors and memory storing computer-readable instructions that, when executed by the one or more hardware processors, cause the one or more hardware processors to perform the steps of method 200.

Method 200 includes generating a 3D scene from at least one 2D image at step 201. This step involves processing the input 2D image to perform a 2D-to-3D reconstruction, which results in a volumetric representation of the scene. The system can employ a deep learning model, such as a CNN, that has been configured to determine spatial information from the visual data of a single image or a sequence of images. In some implementations, the model first generates a depth map, which estimates the distance of each point in the scene from the original camera's perspective. This depth information is then used to construct the geometric structure of the environment, such as a 3D mesh or a point cloud.

To further refine the 3D scene, the original 2D image or images can be used as a texture map, which is applied to the surfaces of the generated 3D mesh to provide a realistic visual appearance. Techniques like semantic segmentation may also be used to identify and classify different objects and regions within the image, such as buildings, foliage, or the sky. This classification aids in creating a more accurate and structured 3D model. More advanced implementations may utilize technologies like NeRFs to synthesize highly detailed and photorealistic 3D representations from a set of input images. Another such advanced technique is Gaussian Splatting, which represents a 3D scene as a collection of colored, transparent 3D Gaussians or shapes. This method allows for the creation of photorealistic scenes that can be rendered in real-time, making it well-suited for interactive experiences. For example, multiple images of a street can be converted into a Gaussian Splatting model, enabling a user to navigate the virtual street smoothly and view it from any angle on a wearable device.

In some implementations, when only a single image is provided, the system leverages a trained deep learning model to infer the missing third dimension. This model, typically a CNN, is configured on a dataset comprising pairs of 2D images and their corresponding ground-truth 3D information, such as depth maps captured by specialized sensors like LiDAR or stereo cameras. Through this training, the model can be configured to recognize and interpret monocular depth cues in flat images, such as perspective distortion, texture gradients, relative object sizes, occlusion, and the interplay of lighting and shadows. When processing the new input image, the model applies these learned patterns to estimate a depth value for each pixel, generating a dense depth map in which each pixel's value corresponds to its inferred distance from the virtual camera. In some implementations, when processing the new input image, the model's encoder extracts a high-dimensional feature representation of these cues. The decoder then uses this representation to perform a regression task, outputting a new data structure—a dense depth map—in which each pixel's value corresponds to its inferred distance from the virtual camera. This depth map is then used to construct the 3D geometry of the scene. For instance, the image's pixel grid can be extruded into 3D space based on the depth values, forming a 3D point cloud or a polygonal mesh.

Method 200 further includes generating an image of the 3D scene at step 202. This step is accomplished by positioning a virtual camera within the reconstructed 3D environment to establish a specific viewpoint from which to render the scene. This viewpoint may correspond to the original perspective of the source photograph or be a novel position that allows for new views of the environment. To create an immersive, 3D experience suitable for a wearable device, the system can generate a stereoscopic image by rendering two separate images of the scene from slightly offset virtual camera positions, simulating the interpupillary distance between a user's eyes. The resulting left-eye and right-eye images form a stereoscopic pair that, when viewed on a compatible display, produces a convincing perception of depth and volume.

Method 200 also provides for identifying audio content associated with the 3D scene based on the at least one 2D image at step 203. This step can be performed in several ways, leveraging different analytical techniques to ensure the selected or created audio is contextually appropriate for the scene. In one approach, the system employs an object recognition model, such as a CNN, to analyze the visual data and identify discrete objects, environmental features, or activities. For instance, if the source image is a photograph of a beach, the model might identify the ocean, seagulls, and distant people. The system then queries a pre-populated audio database, which contains a library of sound files mapped to specific object classes. Based on the identified elements, the system selects corresponding audio clips, such as the sound of crashing waves, the calls of seagulls, and the low murmur of a crowd.

Alternatively, the system can utilize generative artificial intelligence to dynamically synthesize audio content. This method offers greater flexibility and can produce unique soundscapes tailored to the specific visual characteristics of the scene. A generative model, configured (i.e., trained) on a dataset pairing images with corresponding audio, can be used to associate visual features with acoustic properties. For example, instead of selecting a generic river sound, such a model could analyze visual cues inferred from the image, such as the river's width, the turbulence of the water, and its proximity to the viewpoint, to generate a sound that accurately reflects a gentle stream versus a powerful, rushing current.

Furthermore, a hybrid approach can combine these techniques. For example, if the source image is a “live photo” that includes a brief, authentic audio sample, a generative model can analyze the acoustic properties of this sample and seamlessly extend it into a longer, continuous ambient track. In another implementation, the system might select a base sound from the database (e.g., a bird's song) and then use a generative model to apply environmental effects based on the geometry of the 3D scene, such as adding reverberation consistent with an open field or attenuation to simulate distance. This combination of object recognition, database retrieval, and generative synthesis provides a powerful and flexible framework for creating a rich, believable, and contextually accurate auditory experience.

In at least one implementation, when the at least one 2D image includes a live photo, which is a media format that combines a still image with a short video sequence and a brief audio sample, the system identifies this embedded audio as additional audio content. As used herein, “additional audio content” refers to an audio recording captured by a microphone contemporaneously with the capture of the at least one 2D image, wherein the audio recording provides an acoustic representation of the environment at the time the image was created. A generative model can then analyze the acoustic properties of this sample and extend it into a longer, continuous ambient track, preserving the authentic sound of the original moment.

In some implementations, in addition to or in place of processing the at least one 2D image, the system can process the 3D scene to identify audio content. This approach leverages the richer spatial information available in the volumetric model. For instance, the system can analyze the geometric properties of the scene to infer environmental characteristics. A 3D model representing a large, enclosed space could prompt the selection of audio with corresponding reverberation, while a dense collection of tree-like geometries could be identified as a forest, triggering the selection of ambient forest sounds. Furthermore, object recognition models can be applied directly to the 3D data, such as a point cloud or mesh, to classify three-dimensional shapes as specific objects (e.g., a vehicle, a building). This 3D-centric analysis can also provide more nuanced input for a generative model, which could synthesize audio based on volumetric properties, such as the scale of a waterfall's 3D mesh or the density of foliage, to create a more accurate and immersive soundscape.

Method 200 further provides for determining audio associated with the image based on a spatialization of the audio content from a perspective associated with the image of the 3D scene at step 204. In at least one implementation, step 203 involves associating each identified audio clip with the 3D coordinates of its corresponding source object within the reconstructed scene. The information used to perform the spatialization is therefore based on the spatial relationship between the sound source and the viewpoint. Specifically, the system uses the position and orientation of the virtual camera, which defines the perspective for the generated image, and the 3D coordinates of the object emitting the sound. This relative positioning information, including distance, azimuth, and elevation, is calculated to determine how the audio should be rendered.

To create a convincing and immersive auditory experience, the system can then apply advanced rendering techniques. For example, binaural audio rendering can be employed, using an HRTF to generate distinct left-ear and right-ear audio signals that contain the subtle time, level, and spectral differences the brain uses to perceive sound directionality. Furthermore, the system can simulate realistic environmental acoustics based on the geometry of the 3D scene. This may include applying distance attenuation to make sounds from farther objects quieter, modeling reverberation based on the surfaces within the scene, and simulating occlusion effects where a sound is muffled if an object is between the source and the listener's perspective.

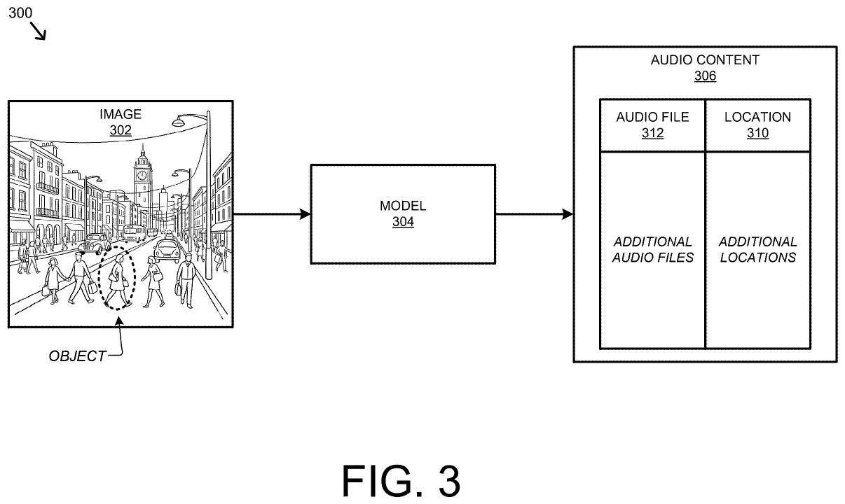

FIG. 3 illustrates an operational scenario 300 of using a generative model to generate audio associated with a 3D scene according to an implementation. Operational scenario 300 includes image 302, model 304, and audio content 306. Audio content 306 includes location 310 and audio file 312. Operational scenario 300 can be performed by one or more computing systems, including a wearable device (e.g., a head-mounted display, smart glasses) and/or a network-based system (e.g., a server), to generate a spatialized audio experience for a 3D image.

In operational scenario 300, a system can process image 302 to determine audio content associated with image 302. Although one image is processed in this example, any number of images can be processed to determine corresponding audio content. To process image 302, the system can be configured to use model 304. Model 304 is a generative artificial intelligence model that has been configured (i.e., trained) to synthesize audio based on visual input. The model analyzes the visual characteristics and features within image 302 to generate contextually appropriate sounds. For example, if image 302 depicts a flowing river, model 304 can assess visual cues such as the river's width, the turbulence of the water, and the surrounding terrain to synthesize a unique sound that accurately reflects a gentle stream or a powerful current. The output of this process is audio content 306, which includes both the synthesized audio file 312 and a corresponding location 310. The location 310 specifies the 3D coordinates of the sound's source within the reconstructed 3D scene, which is used for subsequent spatialization.

As used herein, an “audio file” refers to a digital data structure that encodes sound information, such as a synthesized waveform, in a format suitable for storage and playback by a computing device. This file contains the acoustic data that represents a specific sound generated by the model. As used herein, a “location” refers to a set of 3D coordinates that specifies the virtual origin point of a sound source within the coordinate system of the reconstructed 3D scene. This location data is used by the spatialization process to anchor the corresponding audio file to a specific point in the virtual environment, enabling the rendering of the sound with accurate directional and distance cues relative to a listener's perspective.

In some implementations, model 304 can be configured using a dataset that contains pairs of visual and auditory data. This dataset can be constructed by collecting a number of images and pairing each with a corresponding audio recording or a designed soundscape. For instance, a training example might consist of a photograph of a dense forest, matched with an audio track featuring the sound of wind rustling through leaves, the chirping of specific bird species, and the distant sound of a stream. By processing a multitude of such examples, the model can be configured to establish complex correlations between visual features (e.g., object classes, textures, environmental geometry) and their corresponding acoustic signatures. This configuration or training process enables model 304 to synthesize novel, contextually accurate audio for new input images by inferring the appropriate soundscape from the visual content alone.

In some examples, model 304 can be configured to process the reconstructed 3D scene itself, in addition to or instead of the original 2D image 302. By analyzing the volumetric data of the 3D scene, the model can leverage richer spatial information, including the geometric properties of the environment and the relative distances between objects. For instance, the model could use the depth information derived from the 3D scene to apply more accurate distance attenuation to a synthesized sound, or it could analyze the geometry of the scene to generate realistic environmental acoustic effects, such as reverberation consistent with an enclosed space or an open canyon. This approach enables the synthesis of a soundscape that is more deeply and accurately integrated with the 3D structure of the environment.

Once the audio content is identified, the system can be configured to identify a perspective associated with an image of the 3D scene and generate output audio for the user based on the identified audio content. This is accomplished by spatializing the audio file 312 based on the location 310 within the 3D scene. The system calculates the position and orientation of the sound source relative to the virtual camera's perspective, which represents the user's viewpoint. Using this information, the system can employ rendering techniques like binaural audio to generate distinct left and right ear signals. This process embeds the necessary directional cues to create a convincing perception that the sound is originating from its specific location in 3D space. To further enhance realism, the system can also simulate environmental acoustic effects, such as applying distance attenuation to make sounds from farther objects quieter or modeling reverberation based on the geometry of the 3D scene.

For example, if audio file 312 represented a car at location 310 within the 3D scene (e.g., to the left of the perspective for the image), the system would process the audio using binaural rendering. By applying an HRTF, the system would generate distinct left and right audio channels. For a sound source on the left, the resulting audio would feature subtle timing and amplitude differences, with the sound arriving at the left ear slightly earlier and louder than the right ear. This creates a convincing illusion for the user that the car's engine sound is coming from their left. Additionally, the system could apply distance attenuation, making the sound quieter if the car's location 310 is further away from the virtual camera's perspective.

If the user were to change their perspective within the 3D scene, such as by turning their virtual head to the right, the spatialization of the audio would update dynamically. The system would recalculate the sound's properties based on the new relative position of the car. The HRTF applied would change, shifting the perceived origin of the sound from the left towards the center of the user's auditory field to match the new visual alignment. Similarly, if the user's perspective moved closer to the car at location 310, the sound of the engine would become louder and more distinct due to the reduction in distance attenuation. This real-time adjustment of the spatialized audio based on the user's changing viewpoint is critical for creating a truly interactive and believable immersive experience, ensuring that the auditory and visual components of the scene remain perfectly synchronized.

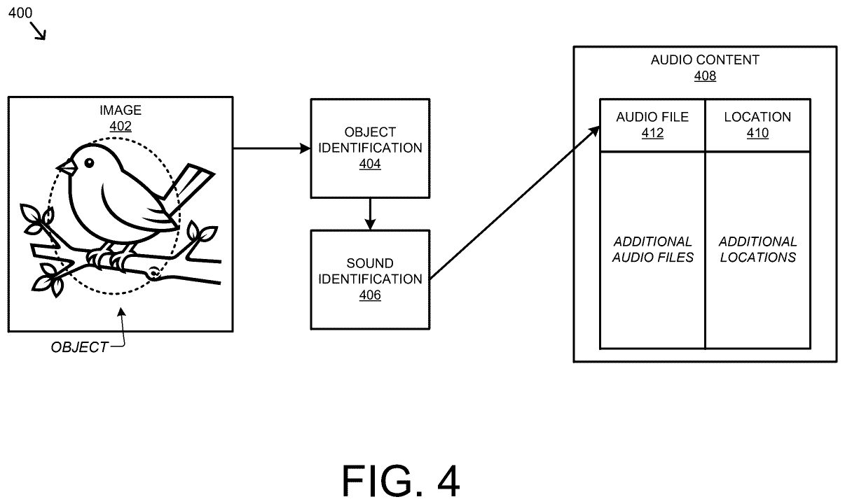

FIG. 4 illustrates an operational scenario 400 of using object identification to determine audio associated with a 3D scene according to an implementation. Operational scenario 400 includes image 402, object identification 404, sound identification 406, and audio content 408. Audio content 408 includes audio file 410 and location 412, where location 412 corresponds to a spatial coordinate of a sound source. Operational scenario 400 can be performed by one or more computing systems, including a wearable device (e.g., a head-mounted display, smart glasses) and/or a network-based system (e.g., a server), to generate a spatialized audio experience for a 3D image.

In operational scenario 400, a system can process image 402 to determine audio content associated with image 402. Although one image is processed in this example, any number of images can be processed to determine corresponding audio content. To process image 402, the system can be configured to use object identification 404. Object identification 404 analyzes the visual content of image 402, which can be the original 2D image or a rendered view from the reconstructed 3D scene, using a model. This model is configured to recognize and classify discrete objects and environmental features within the image. The output of this identification process is a list of classified objects, which is then used by sound identification 406. Sound identification 406 queries a pre-populated audio database, which maps the identified object classes to corresponding sound files. This selection process results in the final audio content 408, which pairs the chosen audio file 410 with the location 412 of the corresponding object within the 3D scene, making it ready for spatialization.

As used herein, an audio file 410 refers to a digital data structure that encodes a discrete sound, such as a pre-recorded sound effect or ambient noise, selected from a database to correspond with an identified object. Concurrently, a location 412 refers to a set of three-dimensional coordinates within the reconstructed 3D scene that specifies the virtual origin point of the sound source associated with the audio file 410. This location data is critical for spatialization, as the data specifies the specific point in the virtual environment to which the audio file is anchored, enabling the sound to be rendered with accurate directional and distance cues relative to the user's perspective.

For example, if image 402 depicts a park scene, object identification 404 may use a model to perform semantic segmentation, identifying objects such as a bird and a fountain. Sound identification 406 then queries a database to retrieve corresponding audio files, such as a bird chirp and the sound of splashing water. The location 412 for each sound is determined by referencing the volumetric data of the reconstructed 3D scene. The system correlates the segmented pixels of each identified object in the original 2D image with the depth map generated during the 3D reconstruction. This process allows the system to calculate the 3D coordinates for the bird and the fountain within the virtual environment. These coordinates are then assigned as the location 412 for their respective audio files, providing the precise spatial information needed to anchor each sound to its source for immersive rendering.

In some implementations, once audio content 408 is identified, the system can generate an image of the 3D scene and process audio content 408 to provide spatialized audio based on audio content 408. This process can be performed from a specific perspective within the 3D scene, which is established by a virtual camera that generates the image. The system uses the location 412 of each sound source in relation to this virtual camera to render the finalized audio. Employing techniques such as binaural audio, the system can generate distinct left and right ear signals that create a convincing perception of sound directionality and depth. For instance, the bird chirp audio would be processed to sound as if it is coming from the bird's specific 3D coordinates, while the fountain's splashing sound would be anchored to its respective location. The system can further enhance realism by simulating environmental acoustics, such as applying distance attenuation to make farther sounds quieter, resulting in a fully immersive soundscape that is precisely synchronized with the visual perspective.

In some examples, the user's perspective changes within the 3D scene, the audio from the system updates dynamically to match. For instance, if the user turns their head to the right, a sound that was on the left will shift toward the center of their hearing to align with the new view. Similarly, if the user moves closer to the car, its engine will sound louder and clearer as distance attenuation is reduced. This constant recalculation of the sound's properties based on the user's viewpoint is critical for an interactive and believable experience, ensuring that auditory and visual elements remain synchronized.

In some implementations, the source 2D image is a multimedia format, such as a “live photo,” which combines a still image with a short video sequence and a corresponding audio sample captured at the moment of the photograph. In this case, the embedded audio sample is identified as additional audio content. This content provides an authentic acoustic snapshot of the environment. The system can then use this audio in several ways. For instance, a generative AI model can analyze the acoustic properties of the sample and seamlessly extend it into a longer, continuous ambient track, preserving the authentic sound of the original moment while creating a more complete and immersive soundscape for the 3D scene. This approach leverages pre-existing, contextually accurate audio to enhance the realism of the final experience.

In an alternative implementation, the system can utilize the additional audio content as an acoustic reference to characterize the original environment. The system can analyze the embedded audio sample to determine ambient acoustic properties, such as the degree of reverberation, the ambient noise floor, or frequency characteristics specific to that location. This derived acoustic profile can then be applied to other sounds that are either selected from the database or generated by an AI model. For example, if the system identifies a bird in the image that was silent in the original audio sample, it can retrieve a bird chirp from a database and then apply the reverberation and ambient noise characteristics extracted from the original sample to this new sound. This ensures that any newly introduced audio elements are seamlessly blended into the authentic soundscape, creating a more cohesive and realistic experience.

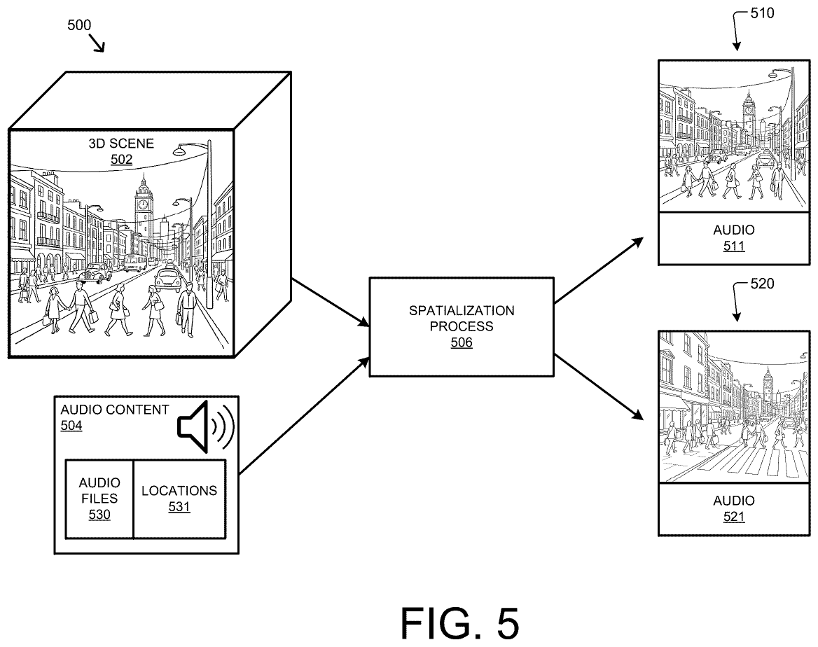

FIG. 5 illustrates an operational scenario 500 of generating different audio for different scene perspectives according to an implementation. Operational scenario 500 includes 3D scene 502, audio content 504, spatialization process 506, image 510 with audio 511, and image 520 with spatial audio 521. Audio content 504 includes audio files 530 and locations 531.

In operational scenario 500, spatialization process 506 identifies a first perspective associated with image 510. This perspective can be defined by a virtual camera, which is positioned and oriented within the 3D scene 502 to establish a specific viewpoint. To capture image 510, the system performs a rendering process where the geometric data of the scene, such as its 3D mesh or point cloud, is projected onto a 2D image plane from the virtual camera's point of view. During this process, textures and materials derived from the original source image are mapped onto the visible surfaces, and a lighting model may be applied to calculate shadows and highlights for enhanced photorealism. The spatialization process 506 then uses this same perspective to render the corresponding spatial audio 511.

Audio content 504 represents the collection of individual sounds intended for the scene, comprising one or more audio files 530 and their corresponding locations 531 within the 3D scene 502. This content is determined by analyzing the visual elements of the scene. For example, an object recognition model can identify a feature, like a bird, and select a corresponding chirp sound from a database, assigning the location 531 to the bird's coordinates in the 3D model. Alternatively, a generative AI model can synthesize an appropriate sound based on the scene's visual characteristics, such as creating the sound of rushing water tailored to the size and turbulence of a waterfall depicted in the scene.

To generate the spatial audio 511, the spatialization process 506 uses the perspective of image 510 to render each sound from audio content 504. For each audio file of audio files 530, the system calculates its position relative to the virtual camera's viewpoint, determining its distance, direction, and elevation. It then applies advanced rendering techniques to create distinct left and right ear signals that embed directional cues. The process can also simulate environmental acoustics, applying effects like distance attenuation to make farther sounds quieter and modeling reverberation based on the geometry of the 3D scene 502. The combination of these effects for all sounds results in a cohesive, immersive soundscape that is precisely matched to the visual perspective of image 510.

Similarly, a second, different perspective is identified for image 520, which results in a different visual rendering and a correspondingly different spatial audio 521, demonstrating how the auditory experience dynamically adapts to the user's viewpoint within the scene.

For example, if 3D scene 502 depicts a park with a fountain in the center and a person playing a guitar on a bench to the right, the associated audio content 504 would include the sound of splashing water at a first location (the fountain's coordinates represented in locations 531) and guitar music at another location (the bench's coordinates represented in locations 531). If the first perspective for image 510 is looking directly at the fountain, the spatialization process 506 would generate audio 511 where the sound of water is centered and the guitar music is perceived as coming from the right. If the user's perspective then shifts to look directly at the guitarist, creating image 520, the spatialization process 506 recalculates the audio. For the new spatial audio 521, the guitar music would now be centered, while the sound of the fountain would shift to be perceived as coming from the user's left. This dynamic adjustment ensures a coherent sensory experience as the user navigates the virtual space.

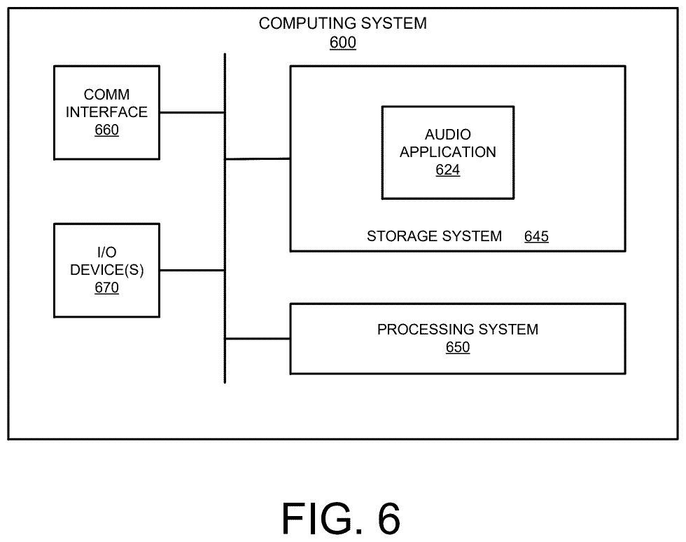

FIG. 6 illustrates a computing system 600 for generating audio in association with a 3D scene according to an implementation. Computing system 600 represents any computing device or devices with which the various operational architectures, processes, scenarios, and sequences disclosed herein for managing audio associated with 3D scenes can be implemented. Computing system 600 can be an XR device or head-worn device in some examples. In some examples, in addition to or instead of a head-mounted display, computing system 600 can also be integrated into a mobile communication device, a wearable computing device, a standalone computing device, a laptop computer, a desktop computer, a server, one of several computing devices in a cloud, or some other sort of computing device, including combinations thereof. Computing system 600 includes storage system 645, processing system 650, communication interface 660, and input/output (I/O) device(s) 670. Processing system 650 is operatively linked to communication interface 660, I/O device(s) 670, and storage system 645. In some implementations, communication interface 660 and/or I/O device(s) 670 may be communicatively linked to storage system 645. Computing system 600 may further include other components, such as a battery and enclosure, that are not shown for clarity.

Communication interface 660 comprises components that communicate over communication links, such as network cards, ports, radio frequency, processing circuitry, software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof. Communication interface 660 may be configured to communicate with external devices, such as servers, user devices, or some other computing device.

I/O device(s) 670 may include computer peripherals that facilitate the interaction between the user and computing system 600. Examples of I/O device(s) 670 may include keyboards, mice, trackpads, monitors, displays, printers, cameras, microphones, external storage devices, sensors, and the like.

Processing system 650 comprises microprocessor circuitry (e.g., at least one processor) and other circuitry that retrieves and executes operating software (i.e., program instructions) from storage system 645. Storage system 645 may include volatile and nonvolatile, removable, and non-removable media implemented in any method or technology for storage of information, such as computer-readable instructions, data structures, program modules, or other data. Storage system 645 may be implemented as a single storage device, but may also be implemented across multiple storage devices or sub-systems. Storage system 645 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 650 is typically mounted on a circuit board that may hold the storage system. The operating software of storage system 645 comprises computer programs, firmware, or other forms of machine-readable program instructions. The operating software of storage system 645 comprises audio application 624. The operating software on storage system 645 may further include an operating system, utilities, drivers, network interfaces, applications, or some other type of software. When read and executed by processing system 650, the operating software on storage system 645 directs computing system 600 to operate as a computing system as described herein. The operating software can provide the operations described in FIGS. 1-5 in at least one implementation.

In at least one implementation, audio application 624 directs processing system 650 to operate to generate a 3D scene from at least one 2D image. The system then identifies audio content that is contextually appropriate for the 3D scene by analyzing the visual information in the source 2D image and/or the generated 3D scene. This identification can be performed in multiple ways. In one implementation, the system identifies one or more objects within the 2D image and selects corresponding audio content from a database. Alternatively, the system can employ generative artificial intelligence to dynamically create the audio content based on the visual characteristics of the scene. If the source 2D image includes associated audio, such as in a live photo, that audio can also serve as a basis for the final soundscape.

After identifying the audio content, the application generates an image of the 3D scene from a specific perspective. The system then determines the final audio to be paired with this image by performing a spatialization of the identified audio content relative to that perspective. This spatialization process involves associating the sounds with the 3D coordinates of their corresponding sources within the scene. To create a realistic and immersive effect, the system can simulate audio propagation, modeling how sound would travel within the virtual environment. Furthermore, the generated image of the scene may be a stereoscopic image, which provides a perception of depth when viewed on a compatible display.

Finally, the application provides the generated stereoscopic image and the corresponding spatialized audio to a user, typically via a wearable device equipped with a display and audio outputs. By spatializing the sound from the perspective of the viewer, the audio is precisely synchronized with the visual content. For example, sounds appear to originate from their respective objects in the 3D space, and their perceived location shifts realistically as the user's viewpoint changes. This creates a cohesive and immersive audiovisual experience, transforming a static 2D image into a dynamic and engaging virtual environment.

Below are example clauses associated with the present disclosure. The described clauses should not be considered exhaustive.

Clause 1. A method comprising: generating a three-dimensional scene from at least one two-dimensional image; generating an image of the three-dimensional scene; identifying audio content associated with the three-dimensional scene based on the at least one two-dimensional image; and determining audio associated with the image based on a perspective for the image in the three-dimensional scene and the audio content.

Clause 2. The method of clause 1, wherein identifying the audio content associated with the three-dimensional scene based on the at least one two-dimensional image comprises: identifying at least one object in the at least one two-dimensional image; and selecting the audio content from a database based on the at least one object.

Clause 3. The method of clause 1 further comprising: identifying additional audio content associated with the at least one two-dimensional image, wherein identifying the audio content associated with the three-dimensional scene is further based on the additional audio content.

Clause 4. The method of clause 1, wherein determining the audio associated with the image based on a perspective for the image in the three-dimensional scene comprises determining the audio associated with the image based on a spatialization of the audio content from the perspective.

Clause 5. The method of clause 4, wherein the spatialization of the audio content comprises a simulation of audio propagation in the three-dimensional scene from the perspective.

Clause 6. The method of clause 1, wherein the image comprises a stereoscopic image.

Clause 7. The method of clause 6 further comprising: providing, via a display of a wearable device, the stereoscopic image; and providing, by at least one audio output device, the audio with the stereoscopic image.

Clause 8. The method of clause 1, wherein the audio content comprises an audio file and a source location for the audio file in the three-dimensional scene.

Clause 9. A computer-readable storage medium having program instructions stored thereon that, when executed by at least one processor, direct the at least one processor to perform a method, the method comprising: generating a three-dimensional scene from at least one two-dimensional image; generating an image of the three-dimensional scene; identifying audio content associated with the three-dimensional scene based on the at least one two-dimensional image; and determining audio associated with the image based on a perspective for the image in the three-dimensional scene and the audio content.

Clause 10. The computer-readable storage medium of clause 9, wherein identifying the audio content associated with the three-dimensional scene based on the at least one two-dimensional image comprises: identifying at least one object in the at least one two-dimensional image; and selecting the audio content from a database based on the at least one object.

Clause 11. The computer-readable storage medium of clause 9, wherein the method comprises: identifying additional audio content associated with the at least one two-dimensional image, wherein identifying the audio content associated with the three-dimensional scene is further based on the additional audio content.

Clause 12. The computer-readable storage medium of clause 9, wherein determining the audio associated with the image based on a perspective for the image in the three-dimensional scene comprises determining the audio associated with the image based on a spatialization of the audio content from the perspective.

Clause 13. The computer-readable storage medium of clause 12, wherein the spatialization of the audio content comprises a simulation of audio propagation in the three-dimensional scene from the perspective.

Clause 14. The computer-readable storage medium of clause 9, wherein the image comprises a stereoscopic image.

Clause 15. The computer-readable storage medium of clause 14, wherein the method further comprises: providing, via a display of a wearable device, the stereoscopic image; and providing, by at least one audio output device, the audio with the stereoscopic image.

Clause 16. The computer-readable storage medium of clause 9, wherein the audio content comprises an audio file and a source location for the audio file in the three-dimensional scene.

Clause 17. A computing system comprising: at least one processor; a computer-readable storage medium operatively coupled to the at least one processor; and program instructions stored on the computer-readable storage medium that, when executed by the at least one processor, direct the computing system to perform a method, the method comprising: generating a three-dimensional scene from at least one two-dimensional image; generating an image of the three-dimensional scene; identifying audio content associated with the three-dimensional scene based on the at least one two-dimensional image; and determining audio associated with the image based on a perspective for the image in the three-dimensional scene and the audio content.

Clause 18. The computing system of clause 17, wherein identifying the audio content associated with the three-dimensional scene based on the at least one two-dimensional image comprises: identifying at least one object in the at least one two-dimensional image; and selecting the audio content from a database based on the at least one object.

Clause 19. The computing system of clause 17, wherein the method further comprises: identifying additional audio content associated with the at least one two-dimensional image, wherein identifying the audio content associated with the three-dimensional scene is further based on the additional audio content.

Clause 20. The computing system of clause 17, wherein the image comprises a stereoscopic image, and wherein the method further comprises: providing, via a display of a wearable device, the stereoscopic image; and providing, by at least one audio output device, the audio with the stereoscopic image.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that, when executed, cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
generating a three-dimensional scene from at least one two-dimensional image;
generating an image of the three-dimensional scene;
identifying audio content associated with the three-dimensional scene based on the at least one two-dimensional image; and
determining audio associated with the image based on a perspective for the image in the three-dimensional scene and the audio content.

2. The method of claim 1, wherein identifying the audio content associated with the three-dimensional scene based on the at least one two-dimensional image comprises:
identifying at least one object in the at least one two-dimensional image; and
selecting the audio content from a database based on the at least one object.

3. The method of claim 1 further comprising:
identifying additional audio content associated with the at least one two-dimensional image,
wherein identifying the audio content associated with the three-dimensional scene is further based on the additional audio content.

4. The method of claim 1, wherein determining the audio associated with the image based on a perspective for the image in the three-dimensional scene comprises determining the audio associated with the image based on a spatialization of the audio content from the perspective.

5. The method of claim 4, wherein the spatialization of the audio content comprises a simulation of audio propagation in the three-dimensional scene from the perspective.

6. The method of claim 1, wherein the image comprises a stereoscopic image.

7. The method of claim 6 further comprising:
providing, via a display of a wearable device, the stereoscopic image; and
providing, by at least one audio output device, the audio with the stereoscopic image.

8. The method of claim 1, wherein the audio content comprises an audio file and a source location for the audio file in the three-dimensional scene.

9. A computer-readable storage medium having program instructions stored thereon that, when executed by at least one processor, direct the at least one processor to perform a method, the method comprising:
generating a three-dimensional scene from at least one two-dimensional image;
generating an image of the three-dimensional scene;
identifying audio content associated with the three-dimensional scene based on the at least one two-dimensional image; and
determining audio associated with the image based on a perspective for the image in the three-dimensional scene and the audio content.

10. The computer-readable storage medium of claim 9, wherein identifying the audio content associated with the three-dimensional scene based on the at least one two-dimensional image comprises:
identifying at least one object in the at least one two-dimensional image; and
selecting the audio content from a database based on the at least one object.

11. The computer-readable storage medium of claim 9, wherein the method comprises:
identifying additional audio content associated with the at least one two-dimensional image,
wherein identifying the audio content associated with the three-dimensional scene is further based on the additional audio content.

12. The computer-readable storage medium of claim 9, wherein determining the audio associated with the image based on a perspective for the image in the three-dimensional scene comprises determining the audio associated with the image based on a spatialization of the audio content from the perspective.

13. The computer-readable storage medium of claim 12, wherein the spatialization of the audio content comprises a simulation of audio propagation in the three-dimensional scene from the perspective.

14. The computer-readable storage medium of claim 9, wherein the image comprises a stereoscopic image.

15. The computer-readable storage medium of claim 14, wherein the method further comprises:
providing, via a display of a wearable device, the stereoscopic image; and
providing, by at least one audio output device, the audio with the stereoscopic image.

16. The computer-readable storage medium of claim 9, wherein the audio content comprises an audio file and a source location for the audio file in the three-dimensional scene.

17. A computing system comprising:
at least one processor;
a computer-readable storage medium operatively coupled to the at least one processor; and
program instructions stored on the computer-readable storage medium that, when executed by the at least one processor, direct the computing system to perform a method, the method comprising:
generating a three-dimensional scene from at least one two-dimensional image;
generating an image of the three-dimensional scene;
identifying audio content associated with the three-dimensional scene based on the at least one two-dimensional image; and
determining audio associated with the image based on a perspective for the image in the three-dimensional scene and the audio content.

18. The computing system of claim 17, wherein identifying the audio content associated with the three-dimensional scene based on the at least one two-dimensional image comprises:
identifying at least one object in the at least one two-dimensional image; and
selecting the audio content from a database based on the at least one object.

19. The computing system of claim 17, wherein the method further comprises:
identifying additional audio content associated with the at least one two-dimensional image,
wherein identifying the audio content associated with the three-dimensional scene is further based on the additional audio content.

20. The computing system of claim 17, wherein the image comprises a stereoscopic image, and wherein the method further comprises:
providing, via a display of a wearable device, the stereoscopic image; and
providing, by at least one audio output device, the audio with the stereoscopic image.
